(19) United States
(12) Patent Application Publication
(10) Pub. No.: US 2010/0283634 A1
(43) Pub. Date: Nov. 11, 2010

(54) CONTROL DEVICE FOR A DISPLAY DEVICE OF A PARKING DEVICE, AND METHOD FOR DISPLAYING

(76) Inventors: Wolfgang Krautter, Leonberg (DE); Michael Scherl, Bietigheim (DE); Clemens Guenther, Ettlingen (DE); Matthias Haug, Pleidelsheim (DE)

Correspondence Address: KENYON & KENYON LLP, ONE BROADWAY, NEW YORK, NY, 10004, US

(21) Appl. No.: 12/733,785

(22) PCT Filed: Jul. 24, 2008
(86) PCT No.: PCT/EP2008/059689

§ 371 Date: Jul. 19, 2010

(30) Foreign Application Priority Data
Sep. 24, 2007 (DE) 10 2007 045 562.5

(51) Int. Cl. B60Q 1/48

(52) U.S. Cl. 340/932.2

(57) ABSTRACT

A control device for a display device of a parking device has: an interface to a first detection device for detecting a parking space when laterally passing the parking space; an interface to a second detection device for detecting a front and/or rear boundary of a parking space when driving into the parking space; an interface to the display device for representing the dimensions of the parking space on the display device, a display of a front and/or a rear boundary of the parking space that was detected only by the first detection device differing from a representation of a front and/or a rear boundary of the parking space that was detected by the second detection device.

### BACKGROUND OF THE INVENTION

1. Field of the Invention

The present invention relates to a control device for a display device of a parking device, and a method for displaying a front and/or rear parking space boundary.

2. Description of Related Art

A device for the semiautonomous support of a parking process for vehicles is already known from published German Patent Application DE 103 54 661 A1. The size of a parking space is determined when a parking space is passed. Subsequently, information and/or instructions about a parking process are communicated to a vehicle operator, a processing unit specifying a parking path into the parking space in light of the determined size of the parking space. If the vehicle has pulled at least partly into the parking space on the basis of the specified parking path, an orientation of the vehicle with regard to the parking space and the maneuvering distance in front of and behind the vehicle is determined once again, in order to determine a corrected further parking path, if necessary.

### BRIEF SUMMARY OF THE INVENTION

In contrast, the control device according to the present invention has the advantage that a driver is informed of the manner in which the front or rear parking space boundary was determined. If the vehicle passes the parking space, then in general the vehicle is maintaining a speed that is customary in road traffic at least in residential areas or in parking lots. The vehicle movement may cause inaccuracies in the measurement of the parking space. In particular, when passing, it is difficult to determine a position of the front and of the rear boundary with precision. For this purpose, in addition to the speed, the angle at which the measuring beams come in, which in relation to the front and rear parking space boundary runs approximately laterally, must be taken into account. Now, if an additional measuring system is available, in particular after the start of the parking process, then the location of a front or a rear parking space boundary may be determined more exactly. More measuring sensors or more measuring time are possibly available. Furthermore, in general the vehicle is driven more slowly during the parking process. If the driver is informed about which measuring system performed a detection of the parking space boundary, the driver is able to recognize immediately how reliable the detection of the parking space boundary is. If an exact measuring result is available, the driver is able to feel more secure during the parking process. If a more exact measuring system is not available, for example, due to a difficult measuring situation or due to a disturbance of one of the measuring systems, the driver is also able to recognize this and use more care when performing the parking process. If an automatic parking system is available, then, as a supplement to the automatic control, the driver may, if indicated, carefully monitor the process of entering the parking space.

Thus, it is advantageous to present the dimensions of the parking space in a bird's eye view, since in this way a driver is able to recognize the dimensions of the parking space simply and intuitively.

Furthermore, it is advantageous to design a control device for calculating a route to a target position within the parking space. This makes it possible not only to give a driver information about the dimensions of the parking space, but also to guide him into the parking space. This may occur on the one hand by issuing instructions, but on the other hand also by an automatic intervention in the drive train and/or the steering of the vehicle, so that the vehicle is guided into the parking space partially automatically or fully automatically by controlling the brake, the drive, and/or the steering.

To increase even further an impression of a reliably operating system, it is advantageous to provide a display of a target position of the vehicle in the display.

For additional safety of the driver, it is advantageous to provide a warning device that warns the driver when a distance to a front and/or rear parking space boundary is undershot.

Corresponding advantages result for the method according to the present invention for displaying a front and/or a rear parking space boundary. A particularly advantageous and intuitively recognizable display is achieved by displaying a parking space boundary as a line whose thickness and/or color is selected as a function of which measuring system or measuring systems detected the front and rear parking space boundary. In one specific embodiment, error bars may possibly be additionally taken into account in the detection such that the size of the error bars has an influence on the line width in the display of the parking space boundaries.

### BRIEF DESCRIPTION OF SEVERAL VIEWS OF THE DRAWING

FIG. 1 shows a schematic representation of a vehicle having a control device according to the present invention.

FIG. 2 shows an exemplary embodiment for a route of a vehicle from a starting position to a target position of a parking space utilizing the method according to the present invention.

FIGS. 3 to 5 show a sequence of a method according to the present invention for displaying a front and/or a rear parking space boundary when pulling a vehicle into a parking space situated on the side of the course of the road.

### DETAILED DESCRIPTION OF THE INVENTION

The control device according to the present invention is preferably usable in motor vehicles that are driven in road traffic and that are to be parked in a parking space with the help of an assistance system. The method according to the present invention is suitable for parking spaces situated at right angles to the course of the road, but in particular also for parking spaces situated parallel to the course of the road, for which, in general, parking proves more difficult than parking in right angle parking spaces.

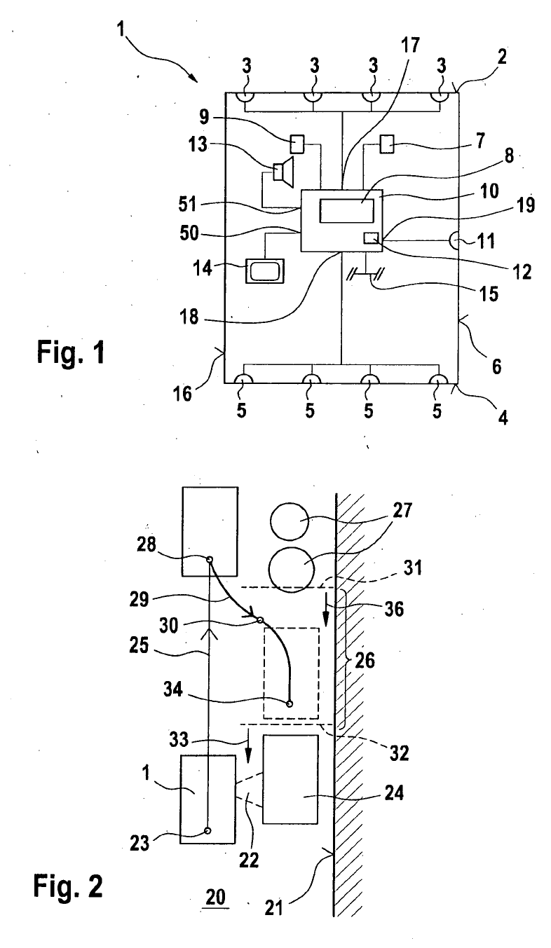

FIG. 1 shows a motor vehicle 1, which is illustrated schematically. Distance sensors 3 are disposed on a front side 2 of motor vehicle 1, and are designed to measure a distance to an obstacle. Distance sensors 3 are implemented as radar sensors or as optical sensors, for example. However, in particular, distance sensors 3 are implemented as ultrasonic sensors that transmit a sound signal, receive in turn a reflected sound signal, and allow for a distance to an obstacle in front of vehicle 1 to be determined from the transit time of the sound signal, taking into account the sound velocity. Distance sensors 3 are evaluated by a control device 10 via an interface 17. Furthermore, distance sensors 5, which are disposed on a back side 4 of the vehicle, are also connected to control device 10 via an interface 18, and preferably are able to detect accordingly a distance to an obstacle situated behind vehicle 1 in the same manner as distance sensors 3.

Furthermore, control device 10 is connected via an interface 19 to a laterally oriented distance sensor 11, which measures the distance to obstacles on a right vehicle side 6. The distance data are correlated with a distance traveled by the vehicle, which distance is detected by a travel sensor 7. Thus, obstacles that are situated on right vehicle side 6 next to the vehicle may be correlated, taking into account the distance traveled, such that a surroundings image of the vehicle on the right vehicle side 6 is determined in relation to a current position of vehicle 1. Control device 10 has a processing unit 8 for determining the surroundings image. In one specific embodiment, the steering angle of the vehicle may additionally be detected via a steering angle sensor 9, so that in addition to the distance traveled, the steering angle set for the vehicle may be taken into account as well.

The use of one lateral distance sensor 11 is shown in the exemplary embodiment according to FIG. 1. However, a plurality of distance sensors may also be disposed on right vehicle side 6. Accordingly, it is also possible to provide additionally or alternatively distance sensors on left vehicle side 16.

Distance sensors 3, 5, 11 may respectively be designed systematically as an in principle identical measuring system. However, since the measurement is used for different application purposes—the point of the lateral measurement being a quick detection of the parking space contours, and the point of the measurement on front and rear vehicle side 2, 4 being in particular an exact detection of the distance—it is possible to use both different measuring programs and also different measuring techniques, for example, radar and ultrasonic measurement.

Control device 10 checks a possible parking space in the vehicle surroundings by comparing it with vehicle data of vehicle 1 stored in a storage device 12 to see whether the parking space is suitable for parking vehicle 1. For this purpose, the length and width dimensions are compared to the detected dimensions of the parking space. If the parking space is suitable, driving instructions are output to the driver of the vehicle via a speaker 13 and/or via a display 14, and by following them, the driver is able to steer vehicle 1 from its current position into the determined parking space. Display 14 is connected to control device 10 via an interface 50, and speaker 13 is connected to control device 10 via an interface 51. If the driver approaches a parking space boundary with vehicle 1, then a warning may be output to the driver via speaker 13 and/or display 14.

However, in an additional specific embodiment, control device 10 may also output control information to control devices in the vehicle, preferably via a databus 15, in order to guide the vehicle at least partially automatically or fully automatically into the parking space. Thus, the vehicle may be accelerated, braked, and/or steered automatically under the control of control device 10, preferably via databus 15.

In order to inform the driver about the driving maneuver he has to perform or about an at least partially automatic process for driving the vehicle into the parking space, the dimensions of the parking space are shown at least schematically on display 14. In this context, for example, it is possible to display the vehicle's situation in a bird's-eye view, in a top view, or in an oblique view. In addition to representing the dimensions of the parking space, in a schematic representation, for example, display 14 also represents the position of the vehicle in the parking space and, in another specific embodiment, also the target position of the vehicle.

The manner in which the parking space is illustrated on display 14 is specified by processing unit 8. In the manner according to the present invention, the display of the boundary of the parking space differs according to whether the distance values for determining the dimensions of the parking space were detected only by distance sensor 11, or whether additionally distance data of distance sensors 3 and/or 5 are also available to locate a boundary of the parking space.

With the aid of FIG. 2, a parking process is explained, in which vehicle 1 drives into the parking space with the aid of control device 10 according to the present invention. FIG. 2 shows vehicle 1 traveling on a road 20 parallel to an edge of the road 21. Lateral distance sensor 11 is activated and transmits in a measurement field 22 a signal that is emitted at first position 23 of the vehicle, which is represented by the middle of the rear axle, in the direction of another vehicle 24 parked on the road. Vehicle 1 now drives down road 20 along path 25. Measurement field 22 does not encounter any obstacle in a free region 26 up to lateral road boundary 21, a curb, for example. Farther in front, the signals of the measurement field meet with planters 27, which delimit free region 26 toward the front.

As a result of the passing speed of the vehicle and the lateral measuring angle, in the case at hand, there may be slight inaccuracies in the determination of the position of a front boundary 31 and a rear boundary 32 of free region 26. Front boundary 31 extends slightly into planter 27. Rear boundary 32 has a relatively large distance to vehicle 24. However, since the parking space having free region 26 is nevertheless viewed as sufficiently large, the vehicle is stopped at second position 28, and the driver is prompted to steer to the right. Alternatively, the steering-wheel motion is carried out automatically.

The driver now drives the vehicle backwards into the parking space along path 29. If the vehicle has driven far enough into the parking space, for example starting from third position 30, there is the possibility of detecting rear boundary 32 of the parking space via back distance sensors 5 of vehicle 1. If rear boundary 32 was detected, the representation of the rear boundary is modified on the display relative to a previous representation in which only a detection of the parking space using at least one lateral sensor on the vehicle was available. Thus, for example, a line representation is modified or in the event that the free region of the parking space is marked off against an obstacle only with regard to its color, a line is inserted into the representation to indicate the position of the rear parking space boundary. If the new position does not correspond with the previously detected position, then preferably the newly determined position is taken into account in the modified representation of the rear parking space boundary on the display. In the exemplary embodiment at hand, the position of the representation of the rear parking space boundary is corrected in arrow direction 33.

If the vehicle has driven farther into the parking space, then front boundary 31 of the parking space may also be rechecked via front distance sensors 3 on vehicle 1. Accordingly, in this instance as well the representation of the position of the front parking space boundary is modified relative to a representation for the case in which only one detection via sensor 11 exists. If the vehicle has reached fourth position 34, then a corrected position of front parking space boundary 31 may be shown to the driver, which is accordingly corrected in arrow direction 36.

Now the driver may decide whether he would still like to carry out a fine correction within the parking space, which is now indeed displayed to him accurately. He is able to recognize in the representation that not only are parking space dimensions determined via distance sensor 11 available at this point, but rather accurate results that were determined via front distance sensors 3 or rear distance sensors 5 are now available.

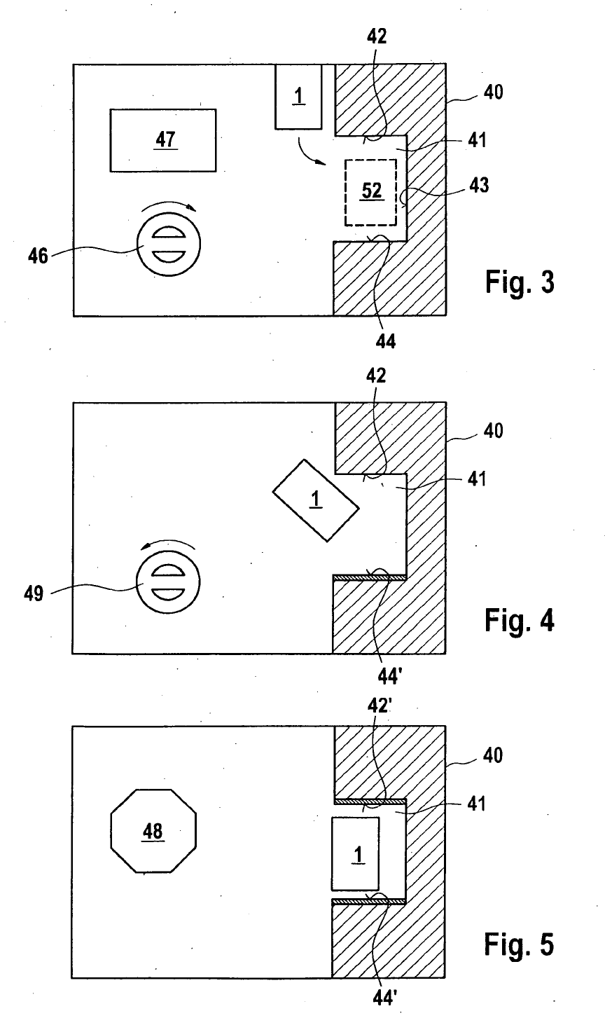

FIGS. 3 through 5 illustrate examples of representations on display 14 for indicating the dimensions of the parking space. A display area 40 of display 14 is shown in FIG. 3. Vehicle 1 is shown in relation to a schematically illustrated parking space 41. Parking space 41 is delimited by a front parking space boundary 42, a side parking space boundary 43, and a rear parking space boundary 44. The displayed positions of the parking space boundaries are based on the measurements obtained as vehicle 1 passed by and are therefore respectively illustrated as a thin line. Furthermore, in this instance, it is also possible to represent the passable region such that it is distinguished from a region that is not passable only in terms of color.

This is indicated in FIG. 3 by the shading of the region that is not passable. In a further development, a direction of travel of vehicle 1 may also be indicated by an arrow display 45. Furthermore, in an additional example embodiment, it is also possible to display alternatively or additionally a steering wheel symbol 46 including an indication of an arrow direction for the steering-wheel motion. Additional information may be displayed in a text window 47, for example. The travel directions may also be displayed in an automatic system, so that the driver recognizes the direction in which the steering wheel is automatically turned. It is also possible for the driver to be instructed not to interfere with the steering wheel.

In one example embodiment, it is also possible to display a target position 52 of the vehicle in display area 40. Target position 52 is plotted in a dashed manner in FIG. 3.

In FIG. 4, the display is illustrated at third position 30 in accordance with the sequence explained in FIG. 2. Vehicle 1 has now partly driven into parking space 41. At the third position, the vehicle has such an angle and such a distance to the back parking space boundary that at this point the back distance sensors are also able to perform a distance measurement. If necessary, a position of the back parking space boundary is now corrected on display 40 in relation to vehicle 1. In particular, however, the back parking space boundary is now represented differently as boundary 44′ than boundary 44 in FIG. 3. Due to the modified representation, a driver is now able to recognize that a measurement has not only been performed by lateral distance sensor 11, as can be seen from FIG. 3, but also in accordance with the different representation of the rear parking space boundary according to FIG. 4, that the position of the back parking space boundary has now been additionally verified by the back distance sensors. In an additional example embodiment, a steering wheel symbol 49 may additionally be displayed, which now indicates to the driver a steering motion to the left.

If vehicle 1 has now traveled into parking space 41, to fourth position 34, then the front parking space boundary may also be detected by front distance sensors 3 of vehicle 1. This is shown in the representation of display area 40 in FIG. 5. Accordingly, the front parking space boundary is also represented in a modified way by another symbol 42′. The driver is now able to recognize that both the front and the rear parking space boundaries were able to be detected by the additional measuring systems of distance sensors 3 and 5. In an additional example embodiment, when fourth position 34 is reached, a stop signal 48 may be displayed additionally in display area 40. Now the driver knows that he may leave his vehicle accordingly in parking space 41.

If, in addition to a lateral sensor, the vehicle has distance sensors only on a front side or only on a back side, a corresponding modified representation may be restricted to the respective side on which an additional distance measurement system is disposed. The other side of the parking space boundary then remains accordingly unchanged.

In another example embodiment, a parking space boundary that was detected using only one measuring system may be represented in a warning color, for example. If the parking space boundary was detected by an additional system, the color display changes from a warning color to a non-warning color, from red to green, for example. Furthermore, it is also possible solely for the line thickness of the parking space boundary to change, from a thin to a thick line, for example. In one example embodiment, an error bar may be determined by control device 10 on the basis of the different measurements for the position of a parking space boundary. The width of the displayed line may then additionally be selected as a function of the size of the calculated error bar. Furthermore, in another example embodiment, it is also possible to transition from a continuous color gradient between a parking space environment and the parking space, when the parking space is detected by a first measuring system, to an abrupt change of color in the event that a second measurement system has additionally or alternatively performed a detection.

1-7. (canceled)

8. A control device for a display device of a parking-assist device in a vehicle, comprising:
an interface to a first detection device for detecting a parking space when laterally passing a parking space having a front boundary and a rear boundary;
an interface to a second detection device for detecting at least one of the front boundary and the rear boundary of the parking space when driving into the parking space; and
an interface to the display device for representing the dimensions of the parking space on the display device, wherein a representation of the at least one of the front boundary and the rear boundary of the parking space that was detected using solely the first detection device differs from a representation of the at least one of the front boundary and the rear boundary of the parking space that was detected by the second detection device.

9. The control device as recited in claim 8, wherein the display device is controlled such that the dimensions of the parking space are represented in a bird's-eye view.

10. The control device as recited in claim 8, wherein the control device is configured to calculate a path from a current vehicle position to a target position of the vehicle inside of the parking space.

11. The control device as recited in claim 10, wherein the control device is configured to provide a representation of the target position on the display device.

12. The control device as recited in claim 11, further comprising:
an interface to a warning device for outputting a warning when the vehicle approaches the at least one of the front boundary and the rear boundary of the parking space.

13. A method for visually representing, on a display device of a parking-assist device located in a vehicle, at least one of a front boundary and a rear boundary of a parking space, comprising:
using at least one of a first measuring method and a second measuring method to detect the dimensions of the parking space, wherein the first measuring method is used to detect the dimensions of the parking space when the vehicle passes the parking space, and wherein the second measuring method is used to detect the dimensions of the parking space after the vehicle has at least partially driven into the parking space; and
representing the at least one of the front boundary and the rear boundary of the parking space differently in the following two situations: (a) when the at least one of the front boundary and the rear boundary of the parking space is detected solely by the first measuring method; and (b) when the at least one of the front boundary and the rear boundary of the parking space is detected by the second measuring method.

14. The method as recited in claim 13, wherein the at least one of the front boundary and the rear boundary of the parking space is represented differently such that lines for representing the at least one of the front boundary and the rear boundary of the parking space differ in at least one of thickness and color.
